(19) United States
(12) Patent Application Publication
(10) Pub. No.: US 2007/0148069 A1
(43) Pub. Date: Jun. 28, 2007

(54) Carbon dioxide recovery from flue gas and the like

(76) Inventors: Shrikar Chakravarti, East Amherst, NY (US); Kenneth Leroy Burgers, East Amherst, NY (US); Amitabh Gupta, Naperville, IL (US); William Robert Williams, Tewksbury, MA (US)

Correspondence Address: PRAXAIR, INC.;LAW DEPARTMENT - M1 557, 39 OLD RIDGEBURY ROAD, DANBURY, CT, 06810-5113, US

(21) Appl. No.: 11/315,019

(22) Filed: Dec. 23, 2005

(51) Int. Cl. B01D 53/14

(52) U.S. Cl. 423/220; 423/437.1

(57) ABSTRACT

Carbon dioxide is recovered in concentrated form from a gas feed stream also containing oxygen by absorbing carbon dioxide and oxygen into an amine solution that also contains another organic component, removing oxygen, and recovering carbon dioxide from the absorbent.

### FIELD OF THE INVENTION

This invention relates generally to the recovery of carbon dioxide and, more particularly, to the recovery of carbon dioxide from a feed mixture which also contains oxygen.

### BACKGROUND OF THE INVENTION

Carbon dioxide is produced from feed streams with high CO₂ purity (which term as used herein means having a carbon dioxide content of ≧95%), where such streams are available, using distillation technology. Examples of such sources include ammonia and hydrogen plant off gases, fermentation sources and naturally-occurring gases in CO₂-rich wells. Typically, liquid CO₂ is produced at a central plant and then transported to users that could be hundreds of miles away, thereby incurring high transportation costs. The lack of sources with high concentrations of carbon dioxide and their distance from customers provides motivation to recover CO₂ from low concentration sources, which are generally available closer to customer sites. Predominant examples of such sources are flue gases, which typically contain 3-25% CO₂ depending upon the amounts of fuel and excess air used for combustion.

To produce high concentration product streams of CO₂ from sources having relatively lower CO₂ concentrations, the CO₂ concentration in the feed gas needs to be upgraded significantly to create a higher-concentration stream that can be sent to a distillation unit. A variety of technologies—including membranes, adsorptive separation (PSA, VPSA, TSA), physical absorption and chemical absorption, can be used for upgrading the CO₂ purity. The economics (capital and operating costs) of the overall scheme depends upon the purity of the feed, the product purity specifications and recovery obtained. For membranes, adsorptive separations and physical absorption, the cost to obtain a certain high product purity is a strong function of the feed purity. On the other hand, chemical absorption provides a convenient means of directly obtaining high purity (>95%) CO₂ vapor in a single step because the costs of this technology are relatively insensitive to the feed CO₂ content. This vapor can be used as is or used as the feed to a CO₂ liquefaction plant.

Chemical absorption can be performed through the use of alkanolamines as well as carbonate salts such as hot potassium carbonate. However, when using carbonate salts, it is necessary for the partial pressure of CO₂ to be at least 15 psia to have any significant recovery. Since flue gases are typically available at atmospheric pressure, and the partial pressure of CO₂ in flue gases varies from about 0.5 to 3 psia, use of chemical absorption with carbonate salts would require compression of the feed gas. This is highly wasteful because of the significant energy expended in compressing the nitrogen that is also present. On the other hand, there exist alkanolamines that can provide adequate recovery levels of CO₂ from lean sources at atmospheric pressure. Thus for recovery of high purity (>95%) CO₂ vapor from sources such as flue gases, chemical absorption with amines is preferred.

The key steps in the chemical absorption process are the absorption of CO₂ from the flue gas into an amine solution at a relatively low temperature (around 100° F.), heating the resulting CO₂-rich amine solution to around 220° F., and subsequently stripping CO₂ from the rich solution at temperatures around 240° F. using steam. Steam consumed in the regeneration step is the most dominant cost component, typically accounting for nearly 75% of the operating cost. Three factors primarily drive the rate of steam consumption: the heat of reaction of CO₂ with the amine, the sensible heat required to heat the CO₂-rich absorbent solution to the desired temperature in the regeneration section, and the latent heat required to evaporate some water in the reboiler that provides the driving force for stripping CO₂ from the CO₂-rich absorbent entering the stripper.

Thus, there remains a need for processes employing absorption and stripping to recover carbon dioxide from low concentration sources thereof, in which the steam consumption per unit of carbon dioxide recovered is reduced.

Typically, flue gases contain significant amounts of oxygen (>2%), which can cause degradation of the amine(s) and other components of the absorbent. The degradation byproducts lead to corrosion problems as well as cause significant deterioration in the overall performance, such as a drop in CO₂ recovery. Thus, there also remains a need for processes for carbon dioxide recovery that combine the aforementioned reduced steam consumption with reduced oxygen-induced degradation of the absorbent.

### BRIEF SUMMARY OF THE INVENTION

The present invention comprises a method for recovering carbon dioxide including the steps of:

(A) passing a feed gas comprising carbon dioxide and oxygen in countercurrent contact with an absorbent solution comprising water, an amine component, and an organic component selected from the group consisting of C₁-C₃ alkanols, ethylene glycol, ethylene glycol monomethyl ether, diethylene glycol, propylene glycol, dipropylene glycol, polyethylene glycols and polyethylene glycol ethers of the formula R⁴—O—(C₂H₄O)ₙ—R⁵ wherein n is 3 to 12, R⁴ is hydrogen or methyl, R⁵ is hydrogen or methyl, or R⁴ is phenyl and R⁵ is hydrogen, polypropylene glycols and polypropylene glycol ethers of the formula R⁶—O—(C₃H₆O)ₚ—R⁷ wherein n is 3 to 6, R⁶ is hydrogen or methyl, R⁷ is hydrogen or methyl, or R⁶ is phenyl and R⁷ is hydrogen, acetamide which is unsubstituted or N-substituted with one or two alkyl groups containing 1 or 2 carbon atoms, glycerol, sulfolane, dimethylsulfoxide, and mixtures thereof, and transferring carbon dioxide and oxygen from said gas into said absorbent solution to obtain a carbon dioxide and oxygen containing absorbent solution;

(B) separating oxygen from the carbon dioxide and oxygen containing absorbent solution to obtain an oxygen depleted carbon dioxide containing absorbent solution;

(C) heating the oxygen depleted carbon dioxide containing absorbent solution to obtain a heated oxygen depleted carbon dioxide containing absorbent solution; and

(D) separating carbon dioxide from the heated oxygen depleted carbon dioxide containing absorbent solution to obtain a carbon-dioxide-rich stream and a regenerated absorbent solution.

In a preferred embodiment, the regenerated absorbent solution obtained in step (D) is recycled to step (A) to comprise at least a portion of the absorbent solution with which feed gas is contacted in step (A).

As used herein, the term “absorption column” means a mass transfer device that enables a suitable solvent, i.e. absorbent, to selectively absorb the absorbate from a fluid containing one or more other components.

As used herein, the term “stripping column” means a mass transfer device wherein a component such as absorbate is separated from absorbent, generally through the application of energy.

As used herein the term “oxygen scavenging gas” means a gas that has an oxygen concentration less than 2 mole percent, preferably less than 0.5 mole percent, and which can be used to strip dissolved oxygen from a liquid.

As used herein, the terms “upper portion” and “lower portion” mean those sections of a column respectively above and below the mid point of the column.

As used herein, the term “indirect heat exchange” means the bringing of two fluids into heat exchange relation without any physical contact or intermixing of the fluids with each other.

### BRIEF DESCRIPTION OF THE DRAWING

FIG. 1 is a schematic representation of an embodiment of the invention.

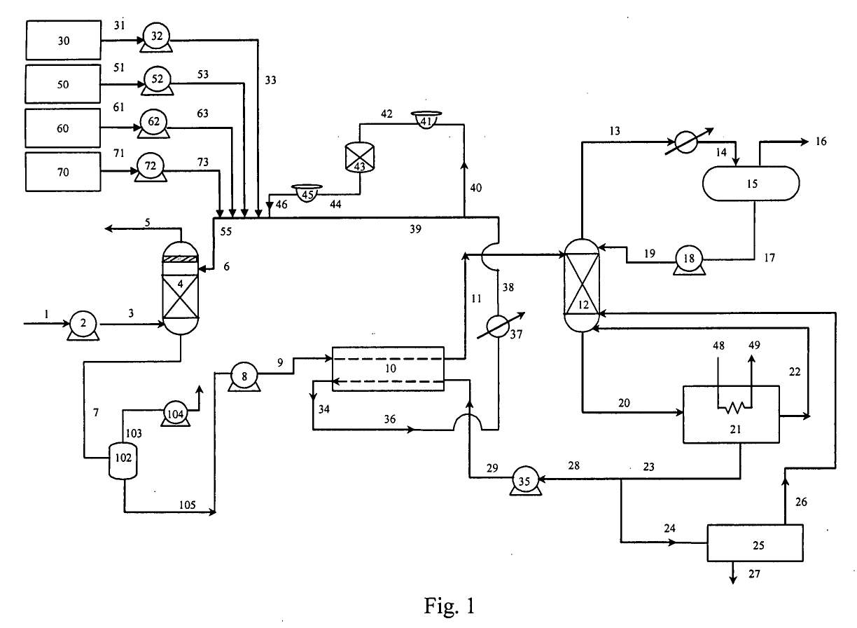

### DETAILED DESCRIPTION OF THE INVENTION

Referring to the Figure, feed gas mixture 1, which typically has been cooled and treated for the reduction of particulates and other impurities such as sulfur oxides (SOx) and nitrogen oxides (NOx), is passed to compressor or blower 2 wherein it is compressed to a pressure generally within the range of from 14.7 to 30 pounds per square inch absolute (psia). Feed gas mixture 1 generally contains from 2 to 50 mole percent carbon dioxide as the absorbate, and typically has a carbon dioxide concentration within the range of from 3 to 25 mole percent. Feed gas mixture 1 also contains oxygen in a concentration generally within the range of from less than 1 to about 18 mole percent. Feed gas mixture 1 may also contain one or more other components such as trace hydrocarbons, nitrogen, carbon monoxide, water vapor, sulfur oxides, nitrogen oxides and particulates. A preferred feed gas mixture is flue gas, by which is meant gas obtained upon the complete or partial combustion of hydrocarbon or carbohydrate material with air, oxygen, or any other gaseous feed that contains oxygen.

Compressed feed gas mixture 3 is passed from blower 2 into the lower portion of absorption column 4 which is operating at a temperature generally within the range of from 40 to 45° C. at the top of the column and at a temperature generally within the range of from 50 to 60° C. at the bottom of the column. The absorption column typically operates at a pressure of atmospheric to 1.5 atmospheres.

Absorbent 6 is passed into the upper portion of absorption column 4. Absorbent 6 comprises water, at least one amine as defined herein, and an organic component which is defined herein.

Amines useful in the invention are single compounds, and blends of compounds, that conform to the formula NR¹R²R³ wherein R¹ is hydroxyethyl, hydroxyisopropyl, or hydroxy-n-propyl, R² is hydrogen, hydroxyethyl, hydroxyisopropyl, or hydroxy-n-propyl, and R³ is hydrogen, methyl, ethyl, hydroxyethyl, hydroxyisopropyl, or hydroxy-n-propyl; or wherein R¹ is 2-(2′-hydroxyethoxy)-ethyl, i.e. HO—CH₂CH₂OCH₂CH₂— and both R² and R³ are hydrogen. Preferred examples of amines which may be employed in absorber fluid 6 in the practice of this invention are monoethanolamine (also referred to as “MEA”), diethanolamine, diisopropanolamine, methyldiethanolamine (also referred to as “MDEA”) and triethanolamine.

The concentrations of the amine(s) in absorbent 6 are typically within the range of from 5 to 80 weight percent, and preferably from 10 to 50 weight percent. For example, a preferred concentration of monoethanolamine for use in the absorbent fluid in the practice of this invention is from 5 to 25 weight percent, more preferably a concentration from 10 to 15 weight percent.

The absorbent 6 also contains an organic component in addition to the amine component. The organic component is one or more of: C₁-C₃ alkanols, ethylene glycol, ethylene glycol monomethyl ether, diethylene glycol, propylene glycol, dipropylene glycol, a polyethylene glycol or polyethylene glycol ether of the formula R⁴—O—(C₂H₄O)ₙ—R⁵ wherein n is 3 to 12, R⁴ is hydrogen or methyl, R⁵ is hydrogen or methyl, or R⁴ is phenyl and R⁵ is hydrogen, a polypropylene glycol or polypropylene glycol ether of the formula R⁶—O—(C₃H₄6O)ₚ—R⁷ wherein n is 3 to 6, R⁶ is hydrogen or methyl, R⁷ is hydrogen or methyl, or R⁶ is phenyl and R⁷ is hydrogen, acetamide which is unsubstituted or N-substituted with one or two alkyl groups containing 1 or 2 carbon atoms, glycerol, sulfolane, dimethylsulfoxide, and mixtures thereof. The organic component is water-soluble, and liquid at standard conditions of 25° C. at atmospheric pressure.

Examples of suitable organic components include methanol, ethanol, the monomethyl ether of ethylene glycol, the monophenyl ether of diethylene glycol, dimethyl acetamide, and N-ethyl acetamide. Other preferred organic components include glycols, glycol ethers, the aforementioned polyethylene glycols and ethers thereof, the aforementioned polypropylene glycols and ethers thereof, glycerol and sulfolane.

The organic component and the amount thereof are chosen so as to satisfy several factors. A primary factor is to reduce the absorbent solution's contributions of sensible and latent heat to the overall steam requirements in the regeneration section. The latent heat is reduced through the reduction of the relative amount of water that needs to be vaporized in the stripping column. A related factor is to decrease the heat capacity of the absorbent solution. Preferably, the heat capacity should be decreased by at least 10%, determined by comparing the heat capacity of a solution comprising water plus one or more amines, but no organic component as defined herein, to the heat capacity of an identical solution containing the same amount of the same one or more amines except that part of the water is replaced with the organic component. Typically the organic component is chosen so that the heat capacity of the absorbent solution decreases from about 0.9-1 cal/g ° C. for the absorbent comprising amine(s) and water but without the organic component, to about 0.65-0.9 cal/g ° C. for the absorbent comprising amine(s), water and organic component.

The choice of the particular organic component should take into consideration several other factors. One factor is flammability, which is important where the absorbent contacts a flue gas containing significant amounts of oxygen in the absorber. For example, alcohols are not preferred organic components where the feed gas from which CO₂ is to be recovered contains enough oxygen to present a highly oxidizing environment. Another factor is environmental considerations, where the gas stream leaving the top of the absorber 4 is vented to the atmosphere without further treatment to remove the organic component or to chemically modify it, e.g. by combusting it. In such situations, organic components should be avoided that may pose health hazards or that may cause atmospheric odor or degradation. Yet another factor is that the organic component should be chemically compatible with the amine(s) as well as with materials employed in the system with which the organic component may come into contact, including not only vessels, pumps and lines but also gaskets, seals, valves and other parts.

Also important in the selection of the organic component and its amount(s) are a) maintaining the vapor pressure of the absorbent solution at values that would minimize absorber vent losses, b) maintaining or increasing the reaction rate of the absorbent solution with CO₂ in the absorber, and c) reducing any tendency of the absorbent solution to foam in the absorber.

The lower heat capacity of the absorbent solution used in this invention can result in an increased temperature within the absorber 4. It is therefore necessary to adjust the solution composition so as not to let the temperature in the absorber 4 exceed 85° C. and preferably 75° C. Also, the absorbent solution with the organic component should be formulated so that its boiling point does not become so high that the stripper needs to be operated at temperatures above about 130° C. at any point, to avoid thermally degrading the amine absorbent in the stripper.

Taking all of the foregoing factors into account, the compositions of the absorbent solution should be in the following ranges. The total amine content should be 20 to 60 wt %, and preferably 25 to 50 wt %. The total of the organic component should comprise 10 to 50 wt. %, and preferably 25 to 40 wt %. Water should comprise 10 to 50 wt. % and preferably 20 to 40 wt. % of the absorbent solution.

Some examples of compositions of typical absorbent solutions that may be used in accordance with the present invention are:

30 wt. % MEA, 30 wt. % ethylene glycol, 40 wt. % water

30 wt. % MEA, 40 wt. % diethylene glycol, 30 wt. % water

25 wt. % MEA, 25 wt. % MDEA, 30 wt. % diethylene glycol, 20 wt. % water

30 wt. % MEA, 20 wt. % MDEA, 30 wt. % diethylene glycol, 20 wt. % water

Within absorption column 4 the feed gas mixture rises in countercurrent flow against downflowing absorbent. Absorption column 4 contains column internals or mass transfer elements such as trays or random or structured packing. As the feed gas rises, most of the carbon dioxide within the feed gas, small amounts of oxygen and other species such as nitrogen, are absorbed into the downflowing absorber liquid resulting in carbon dioxide depleted top vapor at the top of column 4, and in carbon dioxide loaded absorbent containing dissolved oxygen at the bottom of column 4. The top vapor is withdrawn from the upper portion of column 4 in stream 5 and the carbon dioxide loaded absorbent is withdrawn from the lower portion of column 4 in stream 7.

A mist eliminator can be provided at the top of the absorber to trap amine and/or organic component that is entrained in the absorber vent gas 5, which is essentially enriched nitrogen. To aid in removal of amine and organic component, a water wash could be used either in addition to the mist eliminator or instead of the mist eliminator.

Dissolved oxygen eventually causes degradation of the amines and some organic components, thereby leading to corrosion and other operating difficulties. The concentration level of dissolved oxygen in the carbon dioxide loaded absorbent is reduced by next conveying the carbon dioxide and oxygen containing absorbent stream 7 to a stage in which oxygen is removed from the stream.

Complete elimination is ideal but not necessary. Reduction of the oxygen concentration to less than 2 ppm oxygen and preferably less than 0.5 ppm oxygen should be achieved. A preferred technique for oxygen removal is a vacuum flash as shown in the Figure. In this technique, the carbon dioxide and oxygen containing absorbent solution is fed to a tank 102 in which the pressure in the head space over the absorbent solution is maintained subatmospheric, generally within the range of 2 to 12 psia and preferably within the range of from 2.5 to 6 psia, by operation of vacuum pump 104. This condition withdraws oxygen and other dissolved gases from the solution and out of the upper portion of tank 102 via line 103.

Oxygen can also be removed by contacting the solution with an oxygen scavenging gas in a suitable mass transfer device such as a packed column, sparging device, or membrane contactor in place of or in addition to tank 102, but preferably located in the process scheme where tank 102 is located. Equipment and methodology useful for oxygen removal are described in U.S. Pat. No. 6,174,506 and U.S. Pat. No. 6,165,433. Examples of useful oxygen scavenging gases include gases with no or very little oxygen, e.g. nitrogen, carbon dioxide vapor leaving the regeneration section, or carbon dioxide from the storage tank.

It is an important aspect of this invention that the fluid comprising stream 7 either undergoes no heating between its withdrawal from absorption column 4 and its treatment to remove oxygen, or is heated (in aid of the oxygen removal technique) but not so much that the temperature of stream 7 exceeds 160° F. (71° C.).

The resulting carbon dioxide containing oxygen depleted absorbent, typically containing less than 2 ppm oxygen and preferably less than 0.5 ppm oxygen, is withdrawn from the lower portion of tank 102 in stream 105, passed to liquid pump 8 and from there in stream 9 to and through heat exchanger 10 wherein it is heated by indirect heat exchange to a temperature generally within the range of from 90 to 120° C., preferably from 100 to 110° C.

The heated carbon dioxide containing absorbent is passed from heat exchanger 10 in stream 11 into the upper portion of stripping column 12, which operates at a temperature typically within the range of from 100 to 110° C. at the top of the column and at a temperature typically within the range of from 119 to 125° C. at the bottom of the column. As the heated carbon dioxide loaded absorbent flows down through stripping column 12 over mass transfer elements which can be trays or random or structured packing, carbon dioxide within the absorbent is stripped from the absorbent into upflowing vapor, which is generally steam, to produce carbon dioxide rich top vapor stream 13 and carbon dioxide-depleted absorbent liquid.

The carbon dioxide rich top vapor stream 13 is withdrawn from the upper portion of stripping column 12 and passed through reflux condenser 47 wherein it is partially condensed. Resulting two phase stream 14 is passed to reflux drum or phase separator 15 wherein it is separated into carbon dioxide rich gas and into condensate.

The carbon dioxide rich gas is removed from phase separator 15 in stream 16 and recovered as carbon dioxide product fluid having a carbon dioxide concentration generally within the range of from 95 to 99.9 mole percent on a dry basis. By “recovered” as used herein it is meant recovered as ultimate product or separated for any reason such as disposal, further use, further processing or sequestration. Carbon dioxide (stream 16 in the Figure) is generally of high purity (>98%). Depending on the desired use for the carbon dioxide, it can be used without further purification, and after further purification if necessary (such as when the desired use is addition to a beverage or other edible product). Alternatively, this stream can be fed to a liquefaction unit for production of liquid CO₂.

The condensate, which comprises primarily water, amine(s) and the organic component, is withdrawn from phase separator 15 in stream 17. Preferably, this stream is passed through liquid pump 18 and fed as stream 19 into the upper portion of stripping column 12. However, pump 18 is unnecessary if the condensate can flow by gravity to the stripping column. Alternatively, this stream can be reintroduced into the process elsewhere, such as into stream 20.

Remaining absorbent containing amine and organic component and water is withdrawn from the lower portion of stripping column 12 in stream 20. Preferably, this absorbent is recycled to comprise at least a portion of stream 6 fed to absorption column 4. Before that, preferably, stream 20 is passed to reboiler 21 wherein it is heated by indirect heat exchange to a temperature typically within the range of from 119 to 125° C. In the embodiment of the invention illustrated in the Figure, reboiler 21 is driven by saturated steam 48 at a pressure of 28 pounds per square inch gauge (psig) or higher, which is withdrawn from reboiler 21 in stream 49.

The heating of the amine-containing and organic component-containing absorbent in reboiler 21 drives off some water which is passed as steam in stream 22 from reboiler 21 into the lower portion of stripping column 12 wherein it serves as the aforesaid upflowing vapor.

The resulting amine-containing and organic component-containing absorbent is withdrawn from reboiler 21 in liquid stream 23. As required, i.e. continuously or intermittently, a portion 24 of stream 23 is fed to reclaimer 25 where this liquid is vaporized. Addition of soda ash or caustic soda to the reclaimer 25 facilitates precipitation of any degradation byproducts and heat stable amine salts. Stream 27 depicts the disposal of any degradation byproducts and heat stable amine salts. The vaporized amine solution 26 can be reintroduced into stripping column 12 as shown in the Figure. It can also be cooled and directly mixed with stream 6 entering the top of absorption column 4. Also, instead of the reclaimer 25 shown in the Figure, other purification methods such as ion-exchange or electrodialysis could be employed.

The remaining portion 28 of heated amine-containing and organic component-containing absorbent 23 is passed to solvent pump 35 and from there in stream 29 to and through heat exchanger 10 wherein it serves to carry out the aforesaid heating of the carbon dioxide containing absorbent and from which it emerges as cooled absorbent 34. Stream 34 is cooled by passage through cooler 37 to a temperature of about 40° C. to form further-cooled absorbent stream 38. A portion 40 of stream 38 is separated and passed through mechanical filter 41, from there as stream 42 through carbon bed filter 43, and from there as stream 44 through mechanical filter 45, for the removal of impurities, solids, degradation byproducts and heat stable amine salts. Resulting purified stream 46 is recombined with stream 39 which is the remainder of stream 38 to form stream 55.

Storage tank 30 contains makeup amin3, which as required is withdrawn from storage tank 30 in stream 31 and pumped by liquid pump 32 as stream 33 into stream 55. When a second amine is used, storage tank 50 contains makeup for the second amine. The second amine is withdrawn from storage tank 50 in stream 51 and pumped by liquid pump 52 as stream 53 into stream 55. Alternatively, the amine compounds can be preblended, and held in and dispensed from but one storage tank. Third and additional amines can be stored in and dispensed from third and additional storage tanks. Storage tank 60 contains makeup water, which as required is withdrawn from storage tank 60 in stream 61 and pumped by liquid pump 62 as stream 63 into stream 55. Storage tank 70 contains makeup for the organic component, which as required is withdrawn from storage tank 70 in stream 71 and pumped by liquid pump 72 as stream 73 into stream 55 to form stream 6.

The practice of the present invention affords several significant advantages. In particular, less energy is required, per unit of carbon dioxide treated, for the heating and evaporating that are inherent in the process. This is believed to be due to the lower amount of energy required to evaporate the organic component and the lessened amount of water present that needs to be evaporated. Also, the circulation rate of absorbent solutions containing the organic component of the present invention can remain the same as the circulation rate of the absorbent solution without the organic component.

As an illustration, with regard to steam consumption during regeneration, a 30 wt. % MEA solution typically requires around 4 MMBtu/metric ton of CO₂ recovered. An absorbent solution with 30 wt. % MEA, 30 wt. % ethylene glycol (as the organic component referred to herein), and 40 wt. % water is expected to require around 3.2 MMBtu/metric ton of CO₂ recovered. Similarly an aqueous blend of 30 wt. % MEA and 20 wt. % MDEA requires around 3.2 MMBtu/metric ton of CO₂ recovered. An absorbent solution with 30 wt. % MEA, 20 wt. % MDEA, 30 wt. % diethylene glycol (as the organic component referred to herein), 20 wt. % water could potentially lower the steam consumption to around 2.8 MMBtu/metric ton of CO₂ recovered. With regard to heat capacity at a temperature of around 93° C., a 30 wt. % MEA solution has a heat capacity of 0.938 cal/g ° C. whereas an absorbent solution with 30 wt. % MEA, 30 wt. % ethylene glycol and 40 wt. % water has a corresponding value of 0.851 cal/g ° C. An aqueous blend of 30 wt. % MEA and 20 wt. % MDEA has a heat capacity of 0.87 cal/g ° C. whereas an absorbent consisting of 30 wt. % MEA, 20 wt. % MDEA, 30 wt. % diethylene glycol and 20 wt. % water has a corresponding value of 0.744 cal/g ° C.

Further, some organic components, such as ethylene glycol, have been shown to increase the reaction rate of the absorbent solution with CO₂ as well as reduce foaming tendencies. The combined effect is a reduced absorber size, which ultimately reduces capital costs. A side benefit of reduced foaming is lesser operational difficulties.

In addition, the process of the present invention does not require the addition of inhibitors of oxidative degradation of the amine, because oxygen is effectively removed to a level at which oxidative degradation of the amine is not a risk.

What is claimed is:

1. A method for recovering carbon dioxide from a carbon dioxide containing gas comprising:
(A) passing a feed gas comprising carbon dioxide and oxygen in countercurrent contact with an absorbent solution comprising water, an amine component, and an organic component selected from the group consisting of C₁-C₃ alkanols, ethylene glycol, ethylene glycol monomethyl ether, diethylene glycol, propylene glycol, dipropylene glycol, polyethylene glycols and polyethylene glycol ethers of the formula R⁴—O—(C₂H₄O)ₙ—R⁵ wherein n is 3 to 12, R⁴ is hydrogen or methyl, R⁵ is hydrogen or methyl, or R⁴ is phenyl and R⁵ is hydrogen, polypropylene glycols and polypropylene glycol ethers of the formula R⁶—O—(C₃H₆O)ₚ—R⁷ wherein n is 3 to 6, R⁶ is hydrogen or methyl, R⁷ is hydrogen or methyl, or R⁶ is phenyl and R⁷ is hydrogen, acetamide which is unsubstituted or N-substituted with one or two alkyl groups containing 1 or 2 carbon atoms, glycerol, sulfolane, dimethylsulfoxide, and mixtures thereof, and transferring carbon dioxide and oxygen from said gas into said absorbent solution to obtain a carbon dioxide and oxygen containing absorbent solution;
(B) separating oxygen from the carbon dioxide and oxygen containing absorbent solution to obtain an oxygen depleted carbon dioxide containing absorbent solution;
(C) heating the oxygen depleted carbon dioxide containing absorbent solution to obtain a heated oxygen depleted carbon dioxide containing absorbent solution; and
(D) separating carbon dioxide from the heated oxygen depleted carbon dioxide containing absorbent solution to obtain a carbon-dioxide-rich stream and a regenerated absorbent solution.

2. The method of claim 1 wherein the organic component is selected from the group consisting of ethylene glycol, diethylene glycol, propylene glycol, dipropylene glycol, glycerol, and mixtures thereof.

3. The method of claim 1 wherein said amine component is selected from the group consisting of compounds of the formula NR¹R²R³ wherein R¹ is hydroxyethyl, hydroxyisopropyl, or hydroxy-n-propyl, R² is hydrogen, hydroxyethyl, hydroxyisopropyl, or hydroxy-n-propyl, and R³ is hydrogen, methyl, ethyl, hydroxyethyl, hydroxyisopropyl, or hydroxy-n-propyl, or wherein R¹ is 2-(2′-hydroxyethoxy)-ethyl and both R² and R³ are hydrogen, and mixtures thereof.

4. The method of claim 1 wherein said amine component comprises one or more compounds selected from the group consisting of monoethanolamine, diethanolamine, diisopropanolamine, methyldiethanolamine, and triethanolamine.

5. The method of claim 1 wherein the oxygen depleted carbon dioxide containing absorbent solution is heated in step (C) by indirect heat exchange with the regenerated absorbent solution that is recovered in step (E).

6. The method of claim 1 comprising separating oxygen from the carbon dioxide and oxygen containing absorbent solution in step (B) by feeding the solution to a tank in which the pressure over the solution is subatmospheric.

7. The method of claim 1 comprising separating oxygen from the carbon dioxide and oxygen containing absorbent solution in step (B) by passing scavenging gas through the solution.

8. The method of claim 1 wherein the solution obtained in step (A) is not heated before it is subjected to step (B).

9. The method of claim 1 wherein the temperature of the solution obtained in step (A) is kept below 160° F. before it is subjected to step (B).

10. The method of claim 1 wherein the absorbent solution obtained in step (D) is recycled to step (A) to comprise at least a portion of the absorbent solution with which feed gas is contacted in step (A).

11. The method of claim 10 wherein the organic component is selected from the group consisting of ethylene glycol, diethylene glycol, propylene glycol, dipropylene glycol, glycerol, and mixtures thereof.

12. The method of claim 10 wherein said amine component is selected from the group consisting of compounds of the formula NR¹R²R³ wherein R¹ is hydroxyethyl, hydroxyisopropyl, or hydroxy-n-propyl, R² is hydrogen, hydroxyethyl, hydroxyisopropyl, or hydroxy-n-propyl, and R³ is hydrogen, methyl, ethyl, hydroxyethyl, hydroxyisopropyl, or hydroxy-n-propyl, or wherein R¹ is 2-(2′-hydroxyethoxy)-ethyl and both R² and R³ are hydrogen, and mixtures thereof.

13. The method of claim 10 wherein said amine component comprises one or more compounds selected from the group consisting of monoethanolamine, diethanolamine, diisopropanolamine, methyldiethanolamine, and triethanolamine.

14. The method of claim 10 wherein the oxygen depleted carbon dioxide containing absorbent solution is heated in step (C) by indirect heat exchange with the regenerated absorbent solution that is recovered in step (E).

15. The method of claim 10 comprising separating oxygen from the carbon dioxide and oxygen containing absorbent solution in step (B) by feeding the solution to a tank in which the pressure over the solution is subatmospheric.

16. The method of claim 10 comprising separating oxygen from the carbon dioxide and oxygen containing absorbent solution in step (B) by passing scavenging gas through the solution.

17. The method of claim 10 wherein the solution obtained in step (A) is not heated before it is subjected to step (B).

18. The method of claim 10 wherein the temperature of the solution obtained in step (A) is kept below 160° F. before it is subjected to step (B).
